(19) United States
(12) Patent Application Publication
(10) Pub. No.: US 2025/0062081 A1
(43) Pub. Date: Feb. 20, 2025

(54) BI-FUNCTIONAL CAPACITOR DESIGNS FOR A BIPOLAR BATTERY AND METHOD OF MANUFACTURE THEREOF

(71) Applicant: GM GLOBAL TECHNOLOGY OPERATIONS LLC, Detroit, MI (US)

(72) Inventors: Yong Lu, Shanghai (CN); Meiyuan Wu, Shanghai (CN); Zhe Li, Shanghai (CN); Qili Su, Shanghai (CN); Haijing Liu, Shanghai (CN)

(21) Appl. No.: 18/480,621

(22) Filed: Oct. 4, 2023

(30) Foreign Application Priority Data
Aug. 18, 2023 (CN) 202311048584.5

(51) Int. Cl. H01G 11/84; H01M 12/00

(52) U.S. Cl. CPC H01G 11/84; H01M 12/00; H01G 11/38; H01G 11/56

(57) ABSTRACT

A bipolar solid-state battery cell includes a plurality of battery cells, wherein each cell includes a separator, an anode disposed on a first side of the separator and a cathode disposed on a second side of the separator; where the second side is opposedly disposed to the first side. The anode is in electrical communication with an anode current collector and the cathode is in electrical communication with a cathode current collector. A capacitor wall is disposed parallel to at least one external surface of the anode or cathode, where the capacitor wall includes a capacitor active material.

### CROSS-REFERENCE TO RELATED APPLICATIONS

This application claims priority to Chinese Patent Application No. 202311048584.5, filed Aug. 18, 2023, and all the benefits accruing therefrom under 35 U.S.C. § 119, the contents of which in its entirety are herein incorporated by reference.

### INTRODUCTION

The subject disclosure relates to bi-functional capacitor electrode designs for a gel assisted bipolar battery and methods of manufacture thereof.

Polymer blockers are used in gel-assisted bipolar solid-state batteries to avoid the possible leakage of gel electrolytes, especially at high temperatures. The polymer blocker is a passive ingredient in these solid-state batteries and as such occupies valuable space in the battery whilst performing no active function.

FIG. 1 is a depiction of a bipolar solid-state battery cell 100 that comprises a plurality of single cells 101A, 101B, 101C, 101D . . . 100n-1, and so on. Each cell of the plurality of single cells 101A, 101B, 101C, 101D . . . 100n-1, and so on, comprises anodes 104A, 104B, 104C, 104D, . . . , 104n-1, cathodes 108A, 108B, 108C, 108D, . . . , 108n-1, and solid-state electrolyte 106A, 106B, 106C, 106D, . . . , 106n-1. Each single cell has an anode current collector and a cathode current collector 102A, 102B, 102C, 102D, 102E, . . . 102n, which collects a current generated in each single cell. The solid-state electrolyte 106A, 106B, 106C, 106D, . . . , 106n-1 is a gelled electrolyte. Each cell of the plurality of single cells 101A, 101B, 101C, 101D . . . 101n-1, and so on, has a blocker 202 and 204, that prevents the gel from leaking out of the single cell. The blocker 202 and 204 comprises a polymer and prevents the gel electrolyte from leaking out of the single cells.

However, as noted above, the polymeric blocker 202 and 204 is a passive component. It occupies space, but performs no positive energy generating function, thereby reducing the energy generating capacity of the cell. It is therefore desirable to replace the polymeric blocker with a component that generates energy and improves the capacity of the battery cell.

### SUMMARY

A bipolar solid-state battery cell includes a plurality of battery cells, wherein each cell includes a separator, an anode disposed on a first side of the separator and a cathode disposed on a second side of the separator; where the second side is opposedly disposed to the first side. The anode is in electrical communication with an anode current collector and the cathode is in electrical communication with a cathode current collector. A capacitor wall is disposed parallel to at least one external surface of the anode or cathode; where the capacitor wall includes a capacitor active material.

In an embodiment, the capacitor wall is separated from the at least one external surface of the anode or the cathode by an air-gap.

In another embodiment, the air-gap is up to 0.1 millimeters in thickness.

In yet another embodiment, the capacitor wall has a wall thickness of 3 to 100 millimeters.

In yet another embodiment, the capacitor wall contacts at least one external surface of the anode or the cathode.

In yet another embodiment, the capacitor wall contacts at least two external surfaces of the anode or the cathode.

In yet another embodiment, the capacitor wall contacts at least one external surface of the anode or the cathode adjacent to a current collector.

In yet another embodiment, the capacitor wall contacts every surface of the anode or cathode other than a surface that contacts the separator.

In yet another embodiment, the capacitor wall is disposed parallel to at least two external surfaces of the anode or cathode and wherein an air-gap exists between each of the two external surfaces of the anode or cathode and the capacitor wall.

In yet another embodiment, the capacitor wall contacts every surface of the anode and the cathode other than a surface of the anode and the cathode that contacts the separator.

In yet another embodiment, the capacitor walls are symmetrically disposed about the separator.

In yet another embodiment, the capacitor walls are asymmetrically disposed about the separator.

In yet another embodiment, the capacitor wall further comprises an electrically conductive additive, a polymeric binder and a solid-state electrolyte.

In an embodiment, a method of manufacturing a battery cathode or anode with a capacitor wall includes disposing a slurry that contains a capacitor active material on a separator film such that the slurry surfaces are parallel to at least one external surface of the anode or the cathode. The slurry is dried to form the capacitor wall.

In an embodiment, the capacitor wall further includes a conductive additive, a polymeric binder and a solid-state electrolyte.

In yet another embodiment, the capacitor active material is present in an amount of 50 to 99 wt %, the conductive additive is present in an amount of up to 30 wt %, the polymeric binder is present in an amount of up to 20 wt % and the solid-state electrolyte is present in an amount of up to 30 wt %, based on a total weight of the capacitor wall.

In yet another embodiment, the method of manufacturing includes unwinding the separator from a first roll and winding it onto a second roll. The disposing of the slurry occurs between the unwinding and the winding.

In yet another embodiment, the disposing of the slurry on the separator film occurs continuously.

In yet another embodiment, the capacitor wall is separated from the at least one external surface of the anode or the cathode by an air-gap.

In yet another embodiment, the capacitor wall contacts at least one external surface of the anode or the cathode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic depiction of a prior art battery cell that contains polymer blockers for preventing electrolyte leakage;

FIGS. 2A-2D are top-view depictions of various exemplary embodiments of the bipolar solid-state battery cell;

FIG. 3A is a side-view depiction of the features of the cathode in a single cell of the bipolar solid-state battery cell;

FIG. 3B is a side-view depiction of the features of the anode in a single cell of the bipolar solid-state battery cell;

FIG. 4A is a schematic depiction of the formation of a capacitor wall during a continuous process; and

FIG. 4B is a top view of the bipolar electrode before and after the formation of the capacitor wall during a continuous process.

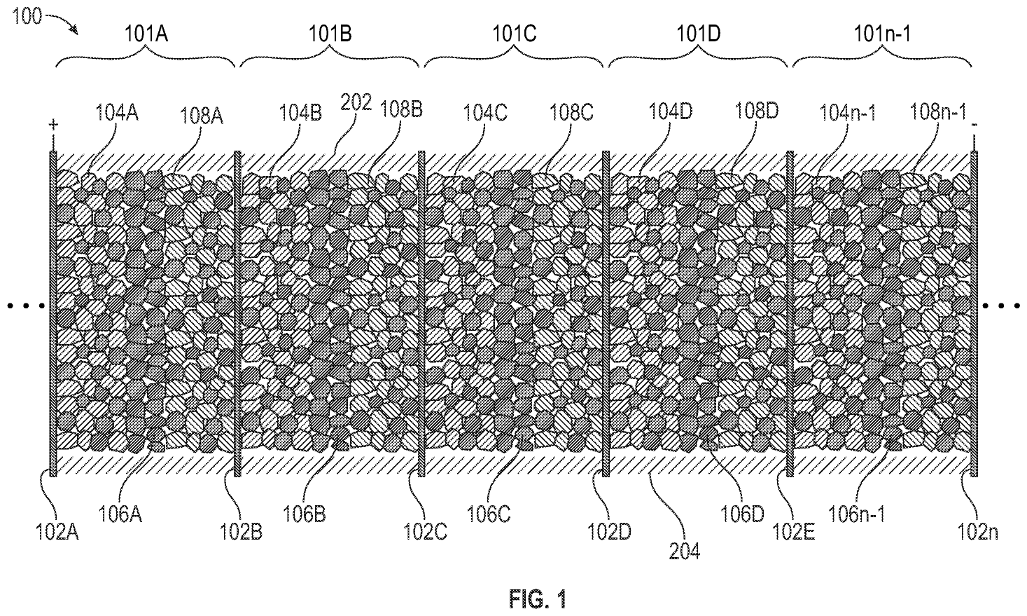

### DETAILED DESCRIPTION

The following description is merely exemplary in nature and is not intended to limit the present disclosure, its application or uses. It should be understood that throughout the drawings, corresponding reference numerals indicate like or corresponding parts and features.

Disclosed herein are bi-functional bipolar electrodes that are used in a gel-containing bipolar solid-state battery. In this battery, the bi-functional bipolar electrode uses a capacitor material that functions as both-a power promoting part and a “sealing blocker” at the edge of electrodes due to its excellent power response and high electrolyte adsorption capability. The capacitor material facilitates current collection from the anode and cathode and can facilitate current transfer to and from the current collector. The capacitor material and the capacitor walls formed therefrom are electrically conducting. It can also absorb the solid-state gel electrolyte, especially at high temperatures thus preventing leakage when the stabilized gel electrolyte structure breaks down or starts flowing. This design eliminates the use of passive polymer blockers which, as detailed above, merely occupy space in the solid-state battery to prevent leakage.

The capacitor material is used as a wall (it will hereinafter be referred to herein as a “capacitor wall”) to surround the electrodes in the cells of the battery in a variety of configurations that are detailed in the following figures.

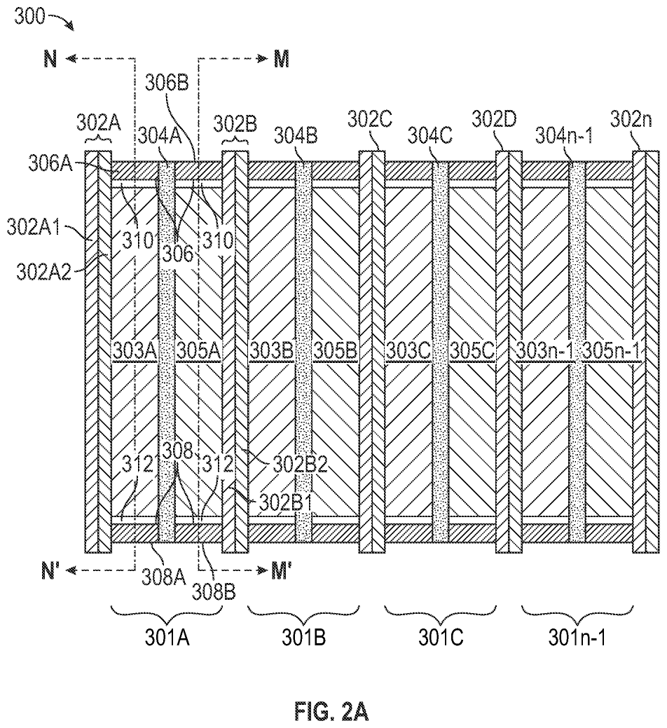

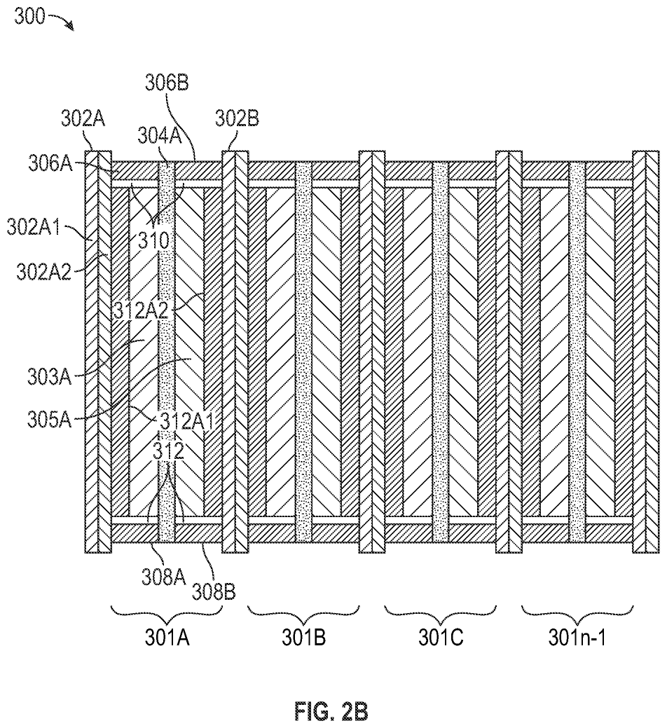

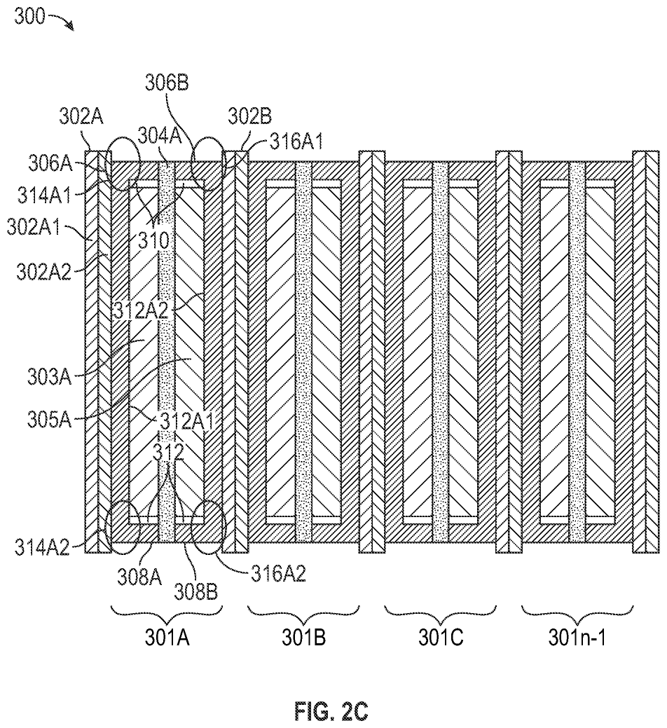

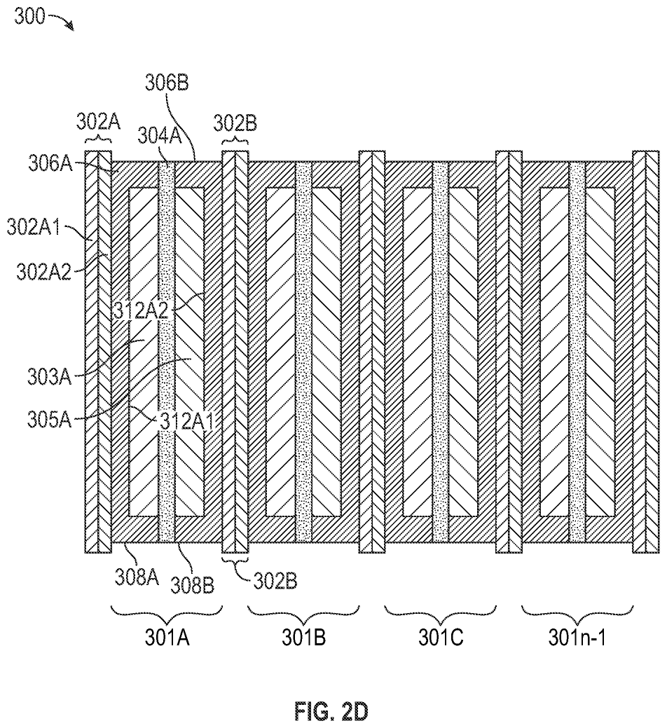

FIGS. 2A-2D are sectional top views that depict exemplary embodiments where the capacitor wall surrounds the electrode materials. While the FIGS. 2A-2D are described as sectional top views, they could also be side-views of the cells of the battery. In other words, the battery depicted in the FIGS. 2A-2D could be turned on its side and the sectional view would be essentially the same. In some embodiments, the capacitor wall does not contact the electrode (the anode or cathode) materials directly and is separated from a side surface of these electrode materials by an air-gap. In this arrangement, the capacitor wall lies only parallel to the side surface of the electrode materials and is separated from the side surface by the air-gap. It does not contact the electrode materials at any point on their surfaces.

In some other embodiments, the capacitor wall does not contact the electrode (the anode or cathode) materials directly and is separated from a side surface of these electrode materials by an air-gap, but it does contact the electrode materials along their bottom surface. In other embodiments, the capacitor wall contacts the electrode (the anode or cathode) material directly at their side surfaces as well as along their bottom surfaces.

In an embodiment, in each single cell of the bipolar solid-state battery cell, a capacitor wall lies parallel to at least one external surface of an anode or cathode and is separated from the at least one external surface of the anode or the cathode by an air-gap. In another embodiment, in each single cell of the bipolar solid-state battery cell, there are at least two capacitor walls, each of which the lie parallel to at least one external surface of an anode or cathode and is separated from the at least one external surface of the anode or the cathode by an air-gap.

In yet another embodiment, there are at least two capacitor walls, each of which lie parallel to an external surface of the anode in each single cell and at least two capacitor walls, each of which lie parallel to an external surface of the cathode in each cell. The at least two capacitor walls may each contact an external wall of the anode or may be separated by an air-gap from an external wall of the anode. The at least two capacitor walls may each contact an external wall of the cathode or may be separated by an air-gap from an external wall of the cathode.

In another embodiment, there is a capacitor wall that contacts at least every external surface of the anode or the cathode, except for the surface of the anode or the cathode that contacts the separator. In one embodiment, the capacitor walls may be symmetrically distributed about the separator. In another embodiment, the capacitor walls may be asymmetrically distributed about the separator.

FIG. 2A depicts a top view of an exemplary bipolar solid-state battery cell 300 that comprises a plurality of single cells 301A, 301B, 301C, . . . 300n-1, and so on. Each cell of the plurality of single cells 301A, 301B, 301C, . . . 301n-1, and so on, comprises anodes 303A, 303B, 303C, . . . 303n, cathodes 305A, 305B, 305C, 305D, . . . , 305n-1, and separators 304A, 304B, 304C, . . . , 304n-1. Each single cell has an associated current collector 302A, 302B, 302C, 302D, . . . 302n, which collects a current generated in each cell. Each current collector contains an anode current collector and a cathode current collector. For example, the current collector 302A (that contacts anode 303A) contains an anode current collector 302A2 and a cathode current collector 302A1. The current collectors 302B, 302C, 302D, . . . 302n similarly each have an anode current collector and a cathode current collector. The anode current collector and the cathode current collector typically contact each other. In one embodiment, the anode current collector and the cathode current collector contact each other directly. In another embodiment, the anode current collector and the cathode current collector form a single unit during the manufacturing of the current collector. A single unit having a cathode and anode current collector is called a clad current collector. In some embodiments, the anode current collector and the cathode current collector contact with each other via a thin (e.g., less than 5 micrometers thick) electrically conducting layer that comprises a different material from the anode current collector and the cathode current collector.

The separators 304A, 304B, 304C, 304D, . . . , 304n-1 prevent contact between the anode materials and cathode materials. Each cell of the plurality of cells 301A, 301B, 301C . . . 301n-1, and so on, has capacitor walls 306 and 308 disposed on opposite sides that prevents the gel from leaking out of the cell. The capacitor walls 306 and 308 are manufactured from a capacitor material composition, which will be described in detail later.

FIGS. 2A-2D are sectional top views that depict different arrangements of the capacitor walls 306 and 308 in the cell 301A and the details of these different arrangements will be explained using only single cell 301A (of each figure) as a reference. In each of the FIGS. 2A-2D, the remaining single cells 301B, 301C, . . . and so on, each have the same structure as the single cell 301A and hence describing their respective structures in detail is avoided in the interests of brevity. Reference will be made to the structures in the remaining single cells 301B, 301C, . . . , and so on, only where there is a substantive difference that warrants an explanation.

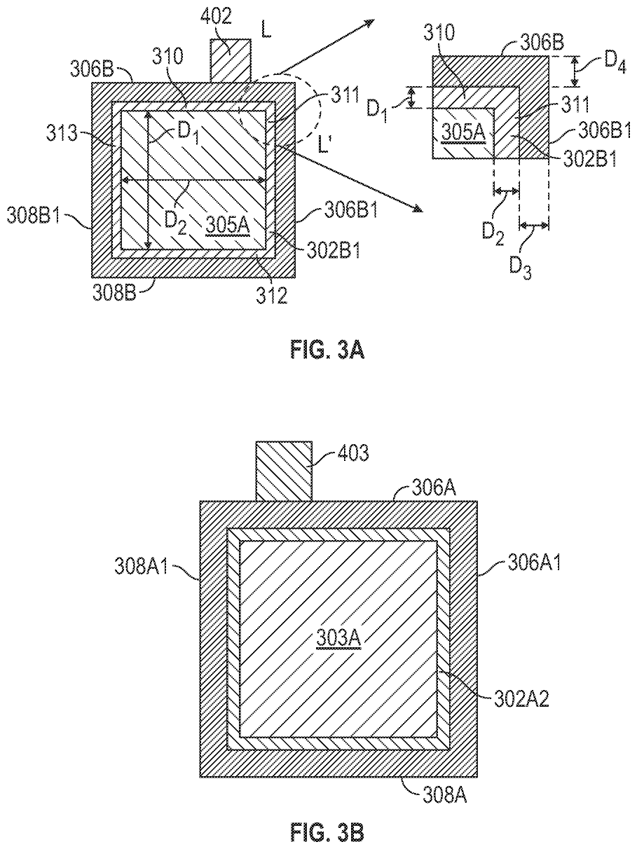

With reference again now to the FIG. 2A, single cell 301A contains two groups of capacitor walls 306 and 308 disposed on its opposing sides parallel to the side surfaces of the anode 303A and cathode 305A. The capacitor wall 306 is split into two parts 306A and 306B that are separated by the separator 304A while the capacitor wall 308 that lies along the opposite side surface (of the anode 303A and cathode 305A) is also split into two parts 308A and 308B that are separated by the separator 304A. Air-gaps 310 and 312 separate the capacitor walls 306 and 308 from the anode 303A and cathode 305A side surfaces, respectively. The air-gaps 310 and 312 are discussed in greater detail with reference to FIGS. 3A and 3B. FIGS. 3A and 3B are isolated top view sections taken along sections MM′ and NN′ in FIG. 2A.

FIG. 3A depicts a side view section of the cathode 305A taken along section MM′. The cathode 305A is separated from the capacitor walls 306B, 306B1. 308B and 308B1 by air-gaps 310, 311, 312 and 313. The cathode 305A directly contacts the cathode current collector 302B1 and is in electrical communication with it. The cathode current collector 302B1 is in electrical communication with a cathode tab 402 that lies outside the cell 301A. The cathode tab from each cell in the battery may be connected together to a terminal (not shown). The cathode 305A is thus surrounded by capacitor walls 306B, 306B1, 308B and 308B1 on all sides but does not contact these capacitor walls directly. It is to be noted that capacitor walls 306B1 and 308B1 and the air-gaps 311 and 313 can only be seen in the sectional view of FIG. 3A (since it represents an entire cross-sectional side view of the single cell 301A whereas the FIG. 2A only represents a sectional top view). A circular section LL′ depicts an expanded view of the air-gaps 310 and 311 between the cathode 305A and the capacitor walls 306B and 306B1.

From the FIG. 3A it may be seen that the cathode 305A has peripheral dimensions of D₁ and D₂ (i.e., the sides of the cathode 305A are of lengths D₁ and D₂). In an embodiment, D₁ may be equal to D₂, in which case the cross-sectional area of the cathode 305A will be a square. In another embodiment, D₁ is not equal to D₂, in which case the cross-sectional area of the cathode 305A will be a rectangle. D₁ and D₂ are independent of each other. It is desirable for D₁ and D₂ to be 50 to 500 millimeters. The air-gaps 310 and 311 which have thicknesses represented by d₁ and d₂ may have a thickness of up to 0.1 millimeters, preferably 0.01 to 0.1 millimeters. The thicknesses d₁ and d₂ may be independent of each other and can be the same or different from each other.

The opposing capacitor walls 306B and 308B each have a thickness represented by D₃, while the opposing capacitor walls 306B1 and 308B1 each have a thickness represented by D₄. D₃ and D₄ can be the same or different from each other. It is to be noted that the thicknesses D₃ and D₄ are independent of each other and have values of 3 to 100 millimeters. In an embodiment, it is desirable for d₁ and d₂ to be equal to each other. In another embodiment, it is desirable for D₃ and D₄ to be equal to each other.

FIG. 3B depicts a side view section of the anode 303A taken along section NN′. The anode 303A is separated from the capacitor walls 306A, 306A1, 308A and 308A1 by air-gaps in a manner similar to those discussed above with respect to the cathode. The size of the air-gaps, the size of the sides of the anode 303A and the thickness of the capacitor walls seen in the FIG. 3B are similar to those detailed for the cathode 305A in the FIG. 3A and will not be elaborated upon again. The anode 303A contacts an anode current collector 302A2. The anode current collector 302A2 is in electrical communication with an anode tab 403. The anode tab 403 from each cell in the battery may be connected together to a terminal (not shown).

FIG. 2B depicts a top view of an exemplary bipolar solid-state battery cell 300 that comprises a plurality of single cells 301A, 301B, 301C . . . 300n-1, and so on, where capacitor wall 312A1 lies between the anode 303A and the current collector pair 302A and where capacitor wall 312A2 lies between the cathode 305A and the current collector pair 302B. In the arrangement depicted in the FIG. 2B, the capacitor walls surround the anode and cathode by a) being in direct contact with one side surface of the anode and one side of the cathode; and b) being separated by an air-gap with another side surface of the anode and the cathode. The remainder of the arrangement of the bipolar solid-state battery cell 300 is the same as that described in the FIG. 2A and will not be detailed here again.

With reference now to the FIG. 2B, the capacitor walls 312A1 and 312A2 contact the anode 303A and the cathode 305A directly along a surface that is perpendicular to the capacitor walls 306 and 308 shown in the FIG. 2A. The capacitor walls 306A and 306B are separated from the anode 303A and cathode 305A by air-gap 310 while capacitor side walls 308A and 308B are separated from the anode 303A and cathode 305A by air-gap 312. The capacitor walls 312A1 and 312A2 are separated from capacitor walls 306A, 306B, 308A and 308B by air-gaps 310 and 312.

FIG. 2C depicts a top view of an exemplary bipolar solid-state battery cell 300 that comprises a plurality of cells 301A, 301B, 301C . . . 300n-1, and so on, where capacitor wall 312A1 lies between the anode 303A and the current collector pair 302A and where capacitor wall 312A2 lies between the cathode 305A and the current collector pair 302B. In this embodiment, the capacitor walls 312A1 and 312A2 are in direct contact with capacitor walls 306A, 306B, 308A and 308B. The capacitor wall 312Al contacts the capacitor wall 306A at a first end 314A1 of the capacitor wall 312A1. It contacts the capacitor wall 308A at a second end 314A2 of the capacitor wall 312A1, where the second end 314A2 is opposite to the first end 314A1. The capacitor wall 312A2 contacts the capacitor wall 306B at a first end 316A1 of the capacitor wall 312A2. It contacts the capacitor wall 308B at a second end 316A2 of the capacitor wall 312A2, where the second end 316A2 is opposite to the first end 316A1. In the arrangements depicted in the FIG. 2C, the capacitor walls 306A and 306B are separated from the anode 303A and the cathode 305A by air-gap 310. The capacitor walls 308A and 308B are separated from the anode 303A and cathode 305A by an air-gap 312.

FIG. 2D depicts another top view of an exemplary bipolar solid-state battery cell 300 that comprises a plurality of single cells 301A, 301B, 301C, . . . 300n-1, and so on, where capacitor wall 312A1 lies between the anode 303A and the current collector pair 302A and where capacitor wall 312A2 lies between the cathode 305A and the current collector pair 302B. In this embodiment, the capacitor wall 312A1 contacts the capacitor walls 306A and 308A at its ends while the capacitor wall 312A2 contacts the capacitor walls 306B and 308B at its ends, as previously described in the FIG. 2C. In this embodiment, no air-gap exists between the capacitor walls 306A and 306B and the anode 303A or between the capacitor walls 308A and 308B and the cathode 305A. The capacitor wall thus partially surrounds the anode and cathode and directly contacts each one of the anode and cathode on three sides.

In a variation of the embodiments depicted in the FIGS. 2B, 2C or 2D, the capacitor walls 312A1 and 312A2 may exist only in the anode or the cathode and not simultaneously on both the anode and cathode for every cell in the bipolar solid-state battery cell 300. In other words, the capacitor walls may be arranged symmetrically or asymmetrically about the separator. This embodiment is not depicted here but can be easily understood by one of ordinary skill in the art. For example, in the FIGS. 2B, 2C and 2D, the cell 301A may have capacitor wall 312A1, 306A, 306B, 308A and 308B, but may not have capacitor wall 312A2, while cell 301B may have all the capacitor walls arranged as depicted in the embodiments shown in the FIGS. 2B, 2C or 2D.

In another embodiment pertaining to asymmetry, the capacitor walls on opposite sides of the separator may have different thickness from each other. For example, all the capacitor walls on one side of the separator may have a greater thickness than those on the other side of the separator. In yet another embodiment, the capacitor walls on opposite sides of the separator may have different compositions from one another. For example, the capacitor walls on one side of the separator may have a first composition, while those on the other side may have a second composition, where the second composition is different from the first composition.

The following paragraphs detail the materials used in each of the different structures depicted in the bipolar solid-state battery cells 300 shown in FIGS. 2A, 2B, 2C or 2D. The materials are detailed with respect to the bipolar solid-state battery cell 300 shown in the FIG. 2A but can apply equally to the battery cells depicted in the FIG. 2B, 2C or 2D.

With reference now again to the FIG. 2A, the anode current collector 302A2 comprises copper while the cathode current collector 302A1 comprises aluminum. The capacitor walls 306A, 306B 308A and 308B comprises a capacitor active material, a conductive additive, a polymeric binder and a solid-state electrolyte.

The capacitor active material used in the capacitor wall comprises carbonaceous materials (e.g., activated carbon, graphene, single wall carbon nanotubes, multiwall carbon nanotubes, or a combination thereof), metal oxides, e.g., MOx (where M is a metal, and where M=Co, Ni, Nb, or a combination thereof), metal sulfides (e.g., TiS₂, CuS, NiS, or a combination thereof), intrinsically conducting polymers (e.g., polyaniline, polyacetylene, polythiophene, polypyrrole, or a combination thereof), or a combination thereof. The capacitor active material is present in an amount of 50 to 99, preferably 55 to 95, and more preferably 60 to 90 weight percent (wt %), based on a total weight of a capacitor wall. Some of the carbonaceous materials listed above are described in detail below. They are also used as conductive additives in the capacitor wall.

The conductive additive used in the capacitor wall comprises an electrically conductive additive. The electrically conducting additive preferably comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof.

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, preferably 10 to 50 nanometers. They have lengths of 20 to 10,000 nanometers, preferably 200 to 5000 nanometers. Aspect ratios greater than 10, preferably greater than 50 and more preferably greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode.

Activated carbon also called activated charcoal, is a form of carbon that has a surface area in excess of 3,000 m²/gm as determined by gas adsorption. It can be used in conjunction with other electrically conducting carbonaceous elements listed herewith. Examples of carbon black or activated carbon that can be used in the electrode-forming slurry are Keltjen™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by o-bonds and a delocalised π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, preferably greater than 10,000 micrometers. The are produced by drawing pitch or polyacrylonitrile polymeric fibers under high pressures and temperatures of over 1500° C., preferably at temperatures greater than 2200° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network in the capacitor wall. In an exemplary embodiment, the carbon nanotubes typically are used in the largest amount when compared with the other carbonaceous ingredients.

The capacitor walls 306A, 306B, 308A and 308B may contain the electrically conducting additive in an amount of up to 30 wt %, preferably less than 20 wt %, and more preferably less than 10 wt %, based on a total weight of the capacitor wall. In an embodiment, if the electrically conducting additive is present, the capacitor wall may contain it in an amount of 1 wt % or more, preferably 2 wt % or more.

The capacitor walls 306A, 306B, 308A and 308B may contain a binder that facilitates retention of the capacitor wall in monolithic form and prevents the materials used in the capacitor wall from being dispersed during the manufacturing process. The binder is preferably a polymeric binder that facilitates bonding of the capacitor active material particles, the electrically conducting additive and the optional solid-state electrolyte. The polymeric binder facilitates shape retention for the capacitor walls. The polymeric binder generally comprises an organic polymer. Examples of organic polymer include poly (tetrafluoroethylene) (PTFE), styrene ethylene butylene styrene copolymer (SEBS), styrene butadiene styrene copolymer (SBS), acrylonitrile butadiene rubber (NBR), styrene-butadiene rubber (SBR), poly(propylene carbonate) PPC, sodium carboxymethyl cellulose (CMC), poly(vinylidene fluoride) (PVDF), poly(vinylidene fluoride-co-hexafluoropropylene) (PVdF-HFP), polyacrylonitrile (PAN), poly(vinylidene fluoride-co-chlorotrifluoroethylene) (P(VDF-CTFE)), poly(vinylidene fluoride-trifluoroethylene) (P(VDF-TeFE)), poly(vinylidene fluoride-trifluoroethylene-chlorofluoroethylene) terpolymer (P(VDF-TrFE-CFE)), or a combination thereof. In a preferred embodiment, the polymeric binder used in the active layer is poly (vinylidene fluoride-hexafluoropropylene) copolymer. The polymeric binder has a weight average molecular weight of 5,000 to 1,000,000 grams per mole, preferably 50,000 to 750,000 grams per mole, and more preferably 75,000 to 500,000 grams per mole measured using gel permeation chromatography with a polystyrene standard.

The polymeric binder is present in an amount of up to 20 wt %, preferably up to 10 wt %, and more preferably up to 1 wt % based on a total weight of the capacitor wall.

The capacitor wall 306A, 306B, 308A and 308B may also contain a solid-state electrolyte. The solid-state electrolyte may be a sulfide solid-state electrolyte, an oxide-based solid-state electrolyte, a metal-doped or aliovalent-substituted oxide solid-state electrolyte, a nitride-based solid-state electrolyte, a halide-based solid-state electrolyte, a hydride-based solid-state electrolyte, or a combination thereof.

The solid-state electrolyte generally comprises a pseudobinary sulfide, a pseudoternary sulfide, a pseudoquarternary sulfide, or a combination thereof. Examples of pseudobinary sulfides include the Li₂S—P₂S₅ system (e.g., Li₃PS₄, Li₇P₃S₁₁ and Li_{9.6}P₃S₁₂), the Li₂S—SnS₂ system (e.g., Li₄SnS₄), the Li₂S—SiS₂ system, the Li₂S—GeS₂ system, the Li₂S—B₂S₃ system, the Li₂S—Ga₂S₃ system, the Li₂S P₂S₃ system, the Li₂S—Al₂S₃ system, or a combination thereof. Examples of pseudoternary sulfides include the Li₂O—Li₂S—P₂S₅ system, the Li₂S—P₂S₅—P₂O₅ system, the Li₂S—P₂S₅—GeS₂ system (e.g., Li_{3.25}Ge_{0.25}P_{0.75}S₄ and Li₁₀GeP₂S₁₂), the Li₂S—P₂S₅—LiX system (where X=F, Cl, Br, or I, examples of which include Li₆PS₅Br, Li₆PS₅Cl, L₇P₂S₈I and Li₄PS₄I), the Li₂S—As₂S₅—SnS₂ system (e.g., Li_{3.833}Sn_{0.833}As_{0.166}S₄), the Li₂S—P₂S₅—Al₂S₃ system, Li₂S—LiX—SiS₂ (where X=F, Cl, Br or I, which includes examples 0.4LiI.0.6Li₄SnS₄ and Li₁₁Si₂PS₁₂. Sulfide-based solid electrolytes include Li₂S—P₂S₅ systems, Li₂S—P₂S₅—MOₓ systems, Li₂S—P₂S₅-MSₓ sysytems, LGPS (Li₁₀GeP₂S₁₂), thio-LISICONS (Li_{3.25}Ge_{0.25}P_{0.75}S₄), Li_{3.4}Si_{0.4}P_{0.6}S₄, Li_{3.4}Si_{0.4}P_{0.6}S₄, Li₁₀GeP₂S_{11.7}O_{0.3}, lithium argyrodites (e.g., Li₆PS₅X (X=Cl, Br, or I), Li_{9.54}Si_{1.74}P_{1.44}S_{11.7}Cl_{0.3}), Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂ Li_{3.833}Sn_{0.833}As_{0.166}S₄), LiI—Li₄, SnS₄, Li₄SnS₄, or a combination thereof.

The oxide-based solid electrolytes include garnets (e.g., Li₇La₃Zr₂O₁₂), perovskites (e.g., Li₃ₓLa_{2/3-x}TiO₃), NASICONs (e.g., Li_{1.4}Al_{0.4}Ti_{1.6}(PO₄)₃ and Li₁₊ₓ AlₓGe₂₋ₓ(PO₄)₃), LISICONs (e.g., Li₂₊₂ₓZn₁₋ₓGeO₄), or a combination thereof.

Metal-doped or aliovalent-substituted oxide solid-state electrolytes may also be used in the capacitor walls. Examples include Al (or Nb)-doped Li₇La₃Zr₂O₁₂, Sb-doped Li₇La₃Zr₂O₁₂, Ga-substituted Li₇La₃Zr₂O₁₂. Cr and V-substituted LiSn₂P₃O₁₂, Al-substituted perovskite, Li_{1+x+y}AlₓTi₂₋ₓSi_{y}P_{3-y}O₁₂, or a combination thereof.

Nitride-based solid-state electrolytes such as, for example, Li₃N, Li₇PN₄, LiSi₂N₃, or a combination thereof may also be used in the capacitor wall.

Hydride-based solid-state electrolytes such as, for example, LiBH₄, LiBH₄—LiX (X=Cl, Br or I), LINH₂, Li₂NH, LiBH₄—LINH₂, Li₃AlH₆, or a combination thereof may also be used in the capacitor wall.

Halide-based solid-state electrolytes such as, for example, LiI, Li₃InCl₆, Li₂CdCl₄, Li₂MgCl₄, Li₂CdI₄, Li₂ZnI₄, Li₃OCl, or a combination thereof may also be used in the capacitor wall.

Borate-based solid-state electrolytes such as, for example, Li₂B₄O₇, Li₂O—B₂O₃—P₂O₅ or a combination thereof may also be used in the capacitor wall. The solid-state electrolyte may be used in the capacitor wall in an amount of up to 50 wt %, preferably less than 30 wt %, and more preferably less than 15 wt %, based on a total weight of the cathode active layer 108. In an embodiment, the solid-state electrolyte may be used in the cathode active layer in an amount of 1 wt % or more, preferably 2 wt % or more, based on a total weight of the cathode active layer 108.

The cathode 305A (see FIG. 2A, 2B, 2C or 2D) comprises a cathode active material, a conductive additive, a binder and a solid-state electrolyte.

The cathode active material comprises lithium cobalt oxide (LCO, sometimes called “lithium cobaltate” or “lithium cobaltite”, one variant of which is LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂(PO₄)₃), and other lithium transition-metal oxides. Surface-coated and/or doped cathode materials mentioned above. e.g., LiNbO₃-coated LiMn₂O₄ and Al-doped LiMn₂O₄, may also be used. Low voltage cathode materials, e.g., lithiated metal oxide/sulfide (e.g., LiTiS₂), lithium sulfide and sulfur, may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)}O₂, LiNiₓMn_{y}Al_{(1-x-y)}O₂, LiNiₓMn₍₁₋ₓ₎O₂, Li₁₊ₓMO₂, where x is equal to or greater than about 0.7, 0.75, 0.80, 0.85, or more and where y is less than 0.15, preferably less than 0.1, In some embodiments, NMC811 may be used, where in the foregoing formula x is about 0.8 and y is about 0.1

The cathode active material is present in the cathode in an amount of 30 to 95 wt %, preferably 40 to 80 wt %, and more preferably 45 to 75 wt %, based on a total weight of the cathode.

The cathode may contain a conductive additive in amounts of up to 30 wt %, preferably up to 20 wt %, and preferably up to 10 wt %, based on a total weight of the cathode. The conductive additive, if present, may also be present in amounts of 1 wt % or greater, preferably 2 wt % or greater, based on a total weight of the cathode. The conductive additives listed above may also be used in the cathode and will therefore not be listed again in the interests of brevity.

The cathode may also contain a polymeric binder in amounts of up to 20 wt %, preferably up to 15 wt %, and preferably up to 10 wt %, based on a total weight of the cathode. The polymeric binder, if present, may also be present in amounts of 1 wt % or greater, preferably 2 wt % or greater, based on a total weight of the cathode. The cathode may also contain a solid-state electrolyte in amounts of up to 30 wt %, preferably up to 25 wt %, and preferably up to 10 wt %, based on a total weight of the cathode. The solid-state electrolyte, if present, may also be present in amounts of 1 wt % or greater, preferably 2 wt % or greater, based on a total weight of the cathode. Both the polymeric binder and the solid-state electrolyte used in the cathode may be the same as those listed above for the capacitor wall and therefore these will not be listed again here.

The anode 303A (see FIGS. 2A, 2B, 2C or 2D) comprises an anode active material, an electrically conductive additive, binder and solid-state electrolyte.

Anode active materials include some of the aforementioned carbonaceous materials, hard carbon, silicon, silicon mixed with graphite, carbon encapsulated silicon particles, Li₄Ti₅O₁₂; transition metals such as, for example, tin, metal oxides, metal sulfides, (e.g., TiO₂, FeS, and the like) lithium metal and alloys, or a combination thereof. Exemplary active materials may include graphite, hard carbon, activated carbon, nanoform carbon, silicon, silicon oxides, carbon encapsulated silicon nanoparticles, or a combination thereof. In some such embodiments, the anode active material may be intercalated with lithium (e.g., using pre-lithiation methods known in the art).

Hard carbon is a solid form of carbon that cannot be converted to graphite by heat-treatment, even at temperatures as high as 3000° C. It is also known as char, or non-graphitizing carbon. Hard carbon is produced by heating carbonaceous precursors to approximately 1000° C. in the absence of oxygen. Among the precursors for hard carbon are polyvinylidene chloride (PVDC), lignin and sucrose. Other precursors, such as polyvinyl chloride (PVC) and petroleum coke, produce soft carbon, or graphitizing carbon. Soft carbon can be readily converted to graphite by heating to 3000° C.

The anode active material is present in the anode in an amount of 30 to 95 wt %, preferably 40 to 80 wt %, and more preferably 45 to 75 wt %, based on a total weight of the anode.

The anode may contain a conductive additive in amounts of up to 30 wt %, preferably up to 20 wt %, and preferably up to 10 wt %, based on a total weight of the anode. The conductive additive, if present, may also be present in amounts of 1 wt % or greater, preferably 2 wt % or greater, based on a total weight of the anode. The conductive additives listed above (for the capacitor wall and the cathode) may also be used in the anode and will therefore not be listed again in the interests of brevity.

The anode may also contain a polymeric binder in amounts of up to 20 wt %, preferably up to 15 wt %, and preferably up to 10 wt %, based on a total weight of the anode. The polymeric binder, if present, may also be present in amounts of 1 wt % or greater, preferably 2 wt % or greater, based on a total weight of the anode. The anode may also contain a solid-state electrolyte in amounts of up to 30 wt %, preferably up to 25 wt %, and preferably up to 10 wt %, based on a total weight of the anode. The solid-state electrolyte, if present, may also be present in amounts of 1 wt % or greater, preferably 2 wt % or greater, based on a total weight of the anode. Both the polymeric binder and the solid-state electrolyte used in the anode may be the same as those listed above for the capacitor wall and therefore these will not be listed again here.

The separator 304A (see FIGS. 2A, 2B, 2C or 2D) comprises a polymeric material and/or a ceramic material that is electrically insulating. The separator 304A can be a polymer-based separator imbedded with gel electrolytes, a free-standing gel membrane or a solid-state electrolyte layer with or without gel electrolytes. Polymeric sheets with or without ceramic coatings may be used as separators. Examples of polymeric sheets include polypropylene or polyethylene sheets. Examples of ceramics that may be used to coat the polymeric sheets include silica (SiO₂), alumina (Al₂O₃), zirconia (ZrO₂), titania (TiO₂), or a combination thereof.

Examples of other high-temperature separators include a polyimide (PI) nanofiber-based nonwoven membrane, a nano-sized alumina and poly (lithium 4-styrenesulfonate)-coated polyethylene membrane, a silica coated polyethylene membrane, a co-polyimide-coated polyethylene membrane, a polyetherimide (PEI) membrane, a bisphenol-acetone diphthalic anhydride (BPADA) and para-phenylenediamine) membrane, an expanded polytetrafluoroethylene reinforced polyvinylidenefluoride-hexafluoropropylene membrane, a sandwich-structured polyvinylidene fluoride/poly(m-phenylene isophthalamide)/polyvinylidene fluoride (PVdF/PMIA/PVdF) nanofibrous membrane, or a combination thereof. These separators may have a thickness of 1 to 50 micrometers.

In another embodiment, the separator 306A may be a free-standing gel membrane having a thickness of 10 to 100 micrometers that comprises up to 30 wt % polymer (e.g., polyacrylonitrile, polyethylene oxide or polyacrylic acid) blended with 70 to 90 wt % of a liquid electrolyte. The liquid electrolyte comprises carbonate-based solvents (e.g., ethylene carbonate (EC), γ-butyrolactone (GBL), dimethyl carbonate (DMC), ethylmethyl carbonate (EMC), diethyl carbonate (DEC), propylene carbonate (PC), or a combination therof) having dissolved therein a concentration of lithium salts greater than 0.8 M (e.g., LiTFSI, LiBOB, LIDFOB, LiFSi, LiBeTi, LiPF₆, LiBF₄, LiAsF₆, LiClO₄, LiTfO, or a combination thereof) and further having at least one of the additives vinylene carbonate (VC), vinylethylene carbonate (VEC), butylene carbonate (BC), fluoroethylene carbonate (FEC), InCl₃, ZnCl₂, or a combination thereof.

In another embodiment, a gel electrolyte may be distributed within the electrodes (the anode 303A or the cathode 305A) and/or within the separating layer 304A. The gel electrolyte may comprise a polymer host in an amount of 0.1 to 50 wt % in addition to a liquid electrolyte in an amount of 50 to 99.9 wt %. The polymer host may comprise polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), or a combination thereof. Other polymers listed above for use as polymeric binders may also be used. The liquid electrolytes are listed above and will not be listed again here.

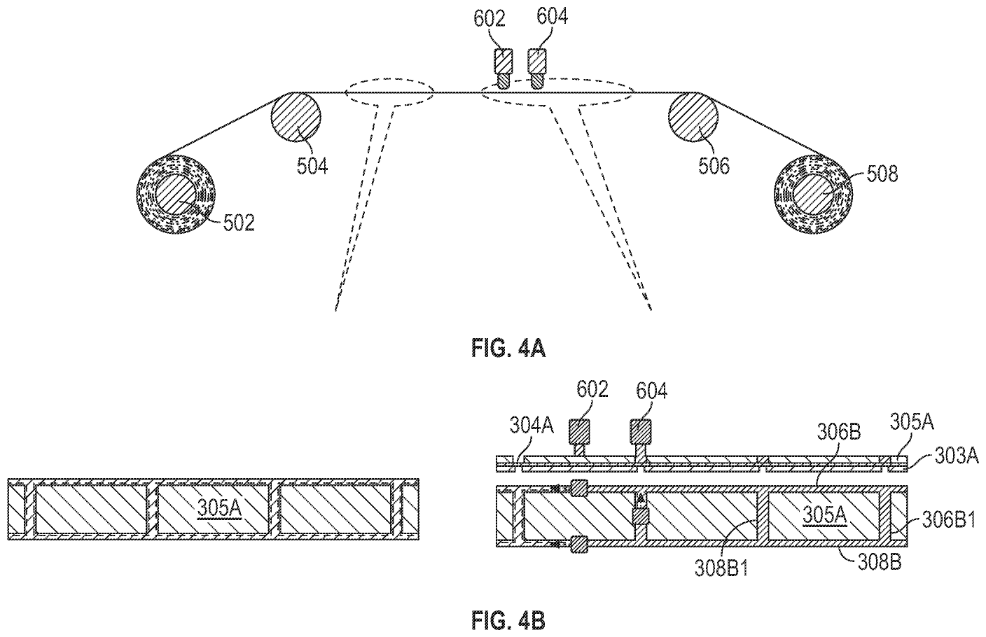

In one method of manufacturing the bipolar solid-state battery cell, a separator film having material that can function as an anode on one surface and material that can function as a cathode on an opposing surface is printed with a material that forms the capacitor wall. FIG. 4A depicts an exemplary method of manufacturing the bipolar solid-state battery cell where a bi-polar electrode (a separator 304A with the anode 303A and cathode 305A disposed on opposing surfaces) is coated with a precursor slurry that forms the capacitor wall 306A, 306A1, 308A and 308A1 (See FIGS. 3A and 3B for a cell of a bipolar solid-state battery cell having an equivalent construction). In the FIG. 4A, a sheet that comprises the bipolar electrode is mounted on a first roller 502 and is unwound during the process of disposing a capacitor electrode slurry on it. The bipolar electrode is unwound from the first roller 502 and is wound on a second roller 508 after having the capacitor electrode slurry disposed on it. During its travel from the first roller 502 to the second roller 508 the bipolar electrode travels over rollers 504 and 506 which guide it (keep it in proper position) so that nozzles 602 and 604 can dispose the capacitor slurry on it. Nozzles 602 dispose the slurry for capacitor walls 306B and 308B, while nozzle 604 moves back and forth across the bipolar electrode to deposit the slurry for capacitor walls 306B1 and 308B1. FIG. 4B depicts a top-view of a bipolar electrode before and after the deposition of the slurry for the capacitor walls. After disposing the slurry for forming the capacitor, the bipolar electrode may be subjected to drying to remove any solvents from the bipolar electrode. The bipolar electrode after solvent removal contains capacitor walls disposed around the anode and cathode thereby forming the bipolar solid-state battery cell.

The composition for forming a capacitor wall is detailed above. In order to form a capacitor wall slurry, the composition disclosed above may be mixed with one of the aforementioned carbonate-based solvents to form the slurry. The slurry is then charged to nozzles 602 and 604, from which it is discharged to the bipolar electrode to form the capacitor walls.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A bipolar solid-state battery cell comprising a plurality of battery cells, wherein each cell comprises:
a separator;
an anode disposed on a first side of the separator;
an anode current collector in electrical communication with the anode;
a cathode disposed on a second side of the separator; where the second side is opposedly disposed to the first side;
a cathode current collector in electrical communication with the cathode;
a capacitor wall disposed parallel to at least one external surface of the anode or cathode; where the capacitor wall comprises a capacitor active material.

2. The cell of claim 1, where the capacitor wall is separated from the at least one external surface of the anode or the cathode by an air-gap.

3. The cell of claim 2, where the air-gap is up to 0.1 millimeters in thickness.

4. The cell of claim 1, where the capacitor wall has a wall thickness of 3 to 100 millimeters.

5. The cell of claim 1, where the capacitor wall contacts at least one external surface of the anode or the cathode.

6. The cell of claim 1, where the capacitor wall contacts at least two external surfaces of the anode or the cathode.

7. The cell of claim 1, where the capacitor wall contacts at least one external surface of the anode or the cathode adjacent to a current collector.

8. The cell of claim 1, where the capacitor wall contacts every surface of the anode or cathode other than a surface that contacts the separator.

9. The cell of claim 1, where the capacitor wall is disposed parallel to at least two external surfaces of the anode or cathode and wherein an air-gap exists between each of the two external surfaces of the anode or cathode and the capacitor wall.

10. The cell of claim 8, where the capacitor wall contacts every surface of the anode and the cathode other than a surface of the anode and the cathode that contacts the separator.

11. The cell of claim 1, where the capacitor walls are symmetrically disposed about the separator.

12. The cell of claim 1, where the capacitor walls are asymmetrically disposed about the separator.

13. The cell of claim 1, where the capacitor wall further comprises an electrically conductive additive, a polymeric binder and a solid-state electrolyte.

14. A method of manufacturing a battery cathode or anode with a capacitor wall, the method comprising:
disposing a slurry that contains a capacitor active material on a separator such that a slurry surface is parallel to at least one external surface of the anode or the cathode; and
drying the slurry to form the capacitor wall.

15. The method of claim 14, where the capacitor wall further comprises a conductive additive, a polymeric binder and a solid-state electrolyte.

16. The method of claim 15, where the capacitor active material is present in an amount of 50 to 99 wt %, the conductive additive is present in an amount of up to 30 wt %, the polymeric binder is present in an amount of up to 20 wt % and the solid-state electrolyte is present in an amount of up to 30 wt %, based on a total weight of the capacitor wall.

17. The method of claim 14, further comprising unwinding the separator from a first roll and winding it onto a second roll; where the disposing of the slurry occurs between the unwinding and the winding.

18. The method of claim 14, where the disposing of the slurry on the separator occurs continuously.

19. The method of claim 14, where the capacitor wall is separated from the at least one external surface of the anode or the cathode by an air-gap.

20. The method of claim 14, where the capacitor wall contacts at least one external surface of the anode or the cathode.
